(19) United States
(12) Patent Application Publication
(10) Pub. No.: US 2016/0125153 A1
(43) Pub. Date: May 5, 2016

(54) System and Method for Transfer of Medical Records to and from the Originating Source to a Distant Care Provider

(71) Applicant: Robert Higgs, Evansville, IN (US)

(72) Inventor: Robert Higgs, Evansville, IN (US)

(21) Appl. No.: 14/528,650

(22) Filed: Oct. 30, 2014

(51) Int. Cl. G06F 19/00

(52) U.S. Cl. CPC G06F 19/3418; G06F 19/322

(57) ABSTRACT

An online system and software application and method for transmitting and transporting patient medical records at the discretion of the user between the user's personal health records cloud based system and point of care physician for the express purpose of receiving medical consultation. Additionally, the system provides the ability to capture, retrieve, transport medical records from point of care physician for return to the cloud based personal records based system with automatic self-parsing and population into the user medical records system. The present invention provides total interoperability of patient medical records information between all present EHR/EMH electronic medical records based systems.

### CROSS REFERENCES TO RELATED APPLICATIONS

U.S. Provisional Application Patent No. 61/897,405, filed Oct. 30, 2013, with title “A Method and Process for Generating, Capture and Transfer of a CCD/CDA Compliant Medical Record to a Disparate System and the Return of same from a Disparate System to the Original System” which is hereby incorporated by reference. Applicant claims priority pursuant to 35 U.S.C. Par. 119(e)(i).

### STATEMENT AS TO RIGHTS TO INVENTIONS MADE UNDER FEDERALLY SPONSORED RESEARCH AND DEVELOPMENT

Not Applicable

### BACKGROUND OF THE INVENTION

1. Field of the Invention

The present disclosure relates to a system and method for capturing, storing, retrieving, and transmitting patient medical records, including longitudinal history and imaging throughout the healthcare system environment, and more particularly, to a system and method for communicating patient medical records that provides optimal medical information service to a subscribed recipient by managing an integrated medical information processing and transport system. The present invention provides total interoperability of patient medical records information between all present EHR/EMR electronic medical records base systems.

2. Brief Description of Prior Art

Comprehensive medical care often requires a patient to visit more than just one doctor. While many patients have established a long-standing relationship with their primary care provider, they are generally unfamiliar with more specialized doctors until medical circumstances necessitate a referral to one. Upon receiving a referral, the patient is usually left to arrange an actual appointment with the specialist. However the patient usually relies upon the patient's primary care provider to timely forward the patient's relevant medical records to the specialist prior to the scheduled appointment. There is little transparency in this process, and under unfavorable circumstances a patient may find himself/herself referred to a doctor who has not been given access to the necessary medical information relating to that patient due to slow delivery, mistaken delivery, and/or failure to deliver. These hurdles may cause delays in medical care, and in some cases even dissuade patients from complying with their primary care provider's recommendation to seek additional medical care from a specialist.

Existing EHR/EMR systems do not always communicate with each other whereby patient information can be exchanged.

Other existing solutions in the prior art only copy medical files to a flash drive in non-structured format which yields it useless in being capable of being captured, uploaded and parsed into disparate medical records systems. Additionally, the medical files or data is generally in an unprotected state and susceptible to unauthorized access and use.

The problem does not end with the sharing of patient's medical records. There is no protocol for sharing of patient information between the primary and secondary care offices. The process requires someone to establish communications between one or more of the patient's primary care physicians and the secondary care physician(s). The inefficacies in managing this process are a drain on both the primary and secondary physician(s) offices. Often times, the patient, who has the least amount of medical knowledge and often an inability to anticipate or articulate the critical nature or timing of the referral, is left calling one or both offices and communicating with a receptionist who cannot independently determine what the next step in the process should be, without again involving either the primary or secondary care physician(s).

The issues described above have been long-standing problems for both physicians and patients, and substantially interfere with the ability to provide appropriate and cost effective medical care. Every existing electronic medical records based system known to applicant relies upon the health care institution and/or care provider to manage the patient's medical information independently.

The present invention provides total interoperability and portability of patient medical records information between all present EHR/EMR electronic medical records based systems. The present system manipulates the patient medical records data present data to be sent to a referred physician into a format that can be retrieved and used in the referred physician's electronic medical records system with the ability to return data in the same specified format for integration back into the originating system database as structured data.

### SUMMARY OF THE INVENTION

In one or more embodiments of the present invention, an apparatus and method are provided that allows patients to manage the process of generating a complete and comprehensive set of patient medical records and the transport of said data to any physician of their choosing for use in providing medical services to the patient with the ability to retrieve and transport all data related to the medical services provided by the physician back to their originating source.

In the preferred embodiment, a system and method is available for sharing by means of portability of patients medical records throughout the continuum of care involving all care providers, either primary and secondary care providers and/or facilities. The present system allows various means of communications and medical records transfer between any health care practitioner practice groups, hospitals and other care provider locations. The system's servers provide a network based service to the patient and all participating care providers, in order to allow the patient's medical records to be made available to transport to selected practitioner groups, hospitals and medical specialists, by providing a web-based data processing service and hardware interface to any medical provider.

The present invention provides for the ability and functionality to generate, a comprehensive set of medical information in compliance with C-CDA/CCR/CCD/CDA interoperability standards from a host electronic personal health records system to a Dongle for use in transport of same to a distant care provider and the ability to open, view, and download said data files in a manner that said data can be uploaded into a disparate system and used by the care provider in connection with providing medical services. Additionally, the invention provides for the ability to upload data associated with any/all medical services provided by the distant physician and transport to the host system whereby the data is parsed into the host medical record as structured data.

The present system is comprised of four (4) components: the Dongle device is used as the disk drive for storage of an HIE application software program. The Dongle for transport of all patient data to and from the originating source to the distant care provider, and the return of the data to the originating system database.

A personal health records module is the originating and ultimately the end receiving point of all patient medical information sent to the care provider and returned to the originating system. The user computer or other web enabled device serves as the host computer that provides web access to the cloud for connection and communication with the source patient personal health records module. And as mentioned, the HIE software application provides the logic and processing of all activities and action of the system.

These new features bring significant benefits to patients, doctors and hospitals, increasing the efficiency of their work flows and improving patient care while reducing administrative costs, and the probability of errors in patient care.

### BRIEF DESCRIPTION OF THE DRAWINGS

FIG. 1 is a schematic representation of the cloud service for implementing the present invention.

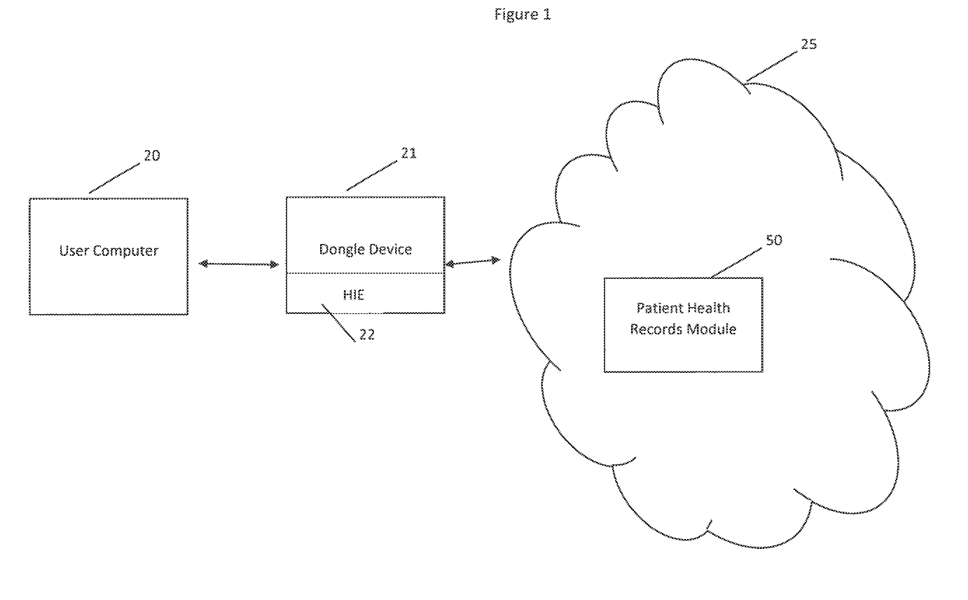

### DESCRIPTION OF THE PREFERRED EMBODIMENT

In the preferred embodiment of the present invention, an apparatus and method is provided that manages the medical records data of a patient across the continuum of care involving multiple care providers or medical institutions for the purposes of receiving medical services involving, but not limited to, the process of physician referrals, whereby a patient is referred from one physician (primary care provider) to another physician (the referred-to or receiving physician or specialist) for a particular medical procedure, or analysis or care. Unlike the prior art, the present invention uses a universal virtual life-time Personal Health Records (PHR) as its foundation. The system is built on a patient-centered architecture that travels with the patient and is owned by the patient rather than the health care institution or medical care provide. As will be described, the present software platform as disclosed consists of components configured and correlated with respect to each other so as to attain the desired objective.

### Transfer of Patient Records

Over the course of a multi-doctor treatment process, a patient's medical records must often be transferred between several offices. Each of these transfers carries with it the possibility of document loss, and the frequent use of physical (paper) patient records only serves to increase this risk.

There is no widely used specialized procedure in place to efficiently facilitate transfer of records between healthcare providers either in private practices or Hospital-based physicians, meaning that a responsible patient and cooperative, well-organized practices must be present to ensure each doctor is properly informed. Three-way communication between the patient and multiple medical services locations is at best cumbersome, and at worst ineffective in ensuring that records are transferred completely and in a timely fashion. Breakdowns in communication and record transfers can lead to unnecessary procedures, inappropriate medication, preventable deaths, and superfluous testing that combine to create additional cost for patients and insurance providers, all the while eroding trust in medical providers and causing frustration on all sides.

The present invention is directed to a solution that provides for the capture, storage, retrieval and transmission of patients medical records including longitudinal history and imaging throughout the healthcare system environment. The present system resolves problems associated with interoperability between existing and legacy health records systems by providing one central all-inclusive repository of patient data by way of a cloud-based personal health records software solution with the ability to generate a continuity of care document in a format as described above that is capable of being parsed into any disparate medical health records system and the ability to retrieve and receive a continuity of care document in such structured format as previously identified back to the central repository whereby the data is parsed back into the patient record based system.

According to the preferred embodiment of the invention described below, a method and apparatus are provided which allows a patient to make his/her necessary medical information available to any physician or care provider organization. Document loss becomes a non-issue, as digitally archived documents cannot be lost or misplaced.

In the preferred embodiment, the present disclosure includes a Dongle device 21 used as the disk drive for storage of an HIE application software program 22 and for transport of all patient data to and from the originating source 50 to the distant care provider 60 and return. The Personal Health Records module 50 is the originating and ultimately the end receiving point of all patient medical information. A user computer 20 or other web enabled device provides web access to the cloud 25 for connecting and communicating with the source patient personal health records module 50. The HIE software application 22 provides the logic and processing for all activities and actions of the present system.

The Personal Health Records module 50 serves as the central repository for all patient medical records. The Personal Health Records module receives, stores, and transmits from, all patient medical data and records. All medical data is made available in structured form using the NIST standard for CCR, CCD, CDA or C-CDA for user by the end-user (physician) in downloading said data into their respective disparate operating system. As a result, the present invention has the ability to allow a user to append medical files of any known format to the CCR/C-CDA/CCD/ICDA transfer document(s) for user by the physician in providing diagnosis.

Any electronic response from the physician, such as comments, suggestions and recommended orders (medications, tests, etc.) can be saved on the Dongle 21 in the structured form, and the Dongle 21 delivered to the user. The system further includes a reconciliation process where the data received from the physician is logically compared with the data in the personal health records module to avoid duplication. In this regard, the reconciliation process is both automatic and manual in that all data received is brought to a user webpage screen and presented to the user with both existing data and newly received data so that the user can either accept or reject the inclusion (into the personal health records module) of the newly received data at a the user's discretion.

A sample of a logic gate would be the software application 22 initiating communications with a web based host system 20 whereby data is extracted from the host system 20 and copied to the software application in a structured format with files encrypted. Another gateway would involve the software 22 generating the CCD/CDA structured data medical record and accompanying HIPAA medical release/power of attorney document for transmission to the end-user (physician). Another gateway would be the use of the Dongle 21 in such a fashion as to be used to store the software application 22 on the drive device 21 in such a way that provides integrity of the application 22 and the integrity and encryption of data within the application.

It is critical to note that the use of the personal health records based system is independent of the medical care provider's own electronic medical records system but yet, capable of communicating with that system or any other medical records based system. This is the founding principle of the present system that cannot be altered.

The present disclosure relates to a system and method for processing medical information, and more particularly, to a system that provides optimal medical information service to the patient and the care provider by managing and integrative medical information processing system Independently operated using a cloud system.

Domestic medical Information processing technology includes Picture Archiving Communication System (PACS), Order Communication System (OCS), and Electronic Medical Record (EMR), which comply with Health Level 7 (HL7). Medical information processing Is independently managed by individual hospitals. Particularly, EMR has been developed into the Electronic Health Record (EHR) concept that is a lifetime electronic health record of individual patients.

However, EHR independently operated need to be integrated according to standardization for high quality medical service of individuals. For this, Integrated system technology is needed, and for example, a cloud computing model is being applied.

Cloud computing is a next generation computing technology in which Software as a Service (SaaS) for web 2.0 service and utility computing are complexly combined.

The service structure of cloud computing may include a server for using IT environment, storage, Infrastructure as a Service (IaaS), Platform as a Service for providing a basis for development of software, Software as a Service (SaaS) in which a computing provider supplies and uses software through Internet. The present system may further include mobile browser technology which is a software-manufacturing technology with an app structure used to independently provide developed services to a user in a smart environment.

### Network Communications

As used herein, database is meant to include any of various types of data repositories and processes for indexing, searching, storage and retrieval from such repositories.

The personal health records module can further include a DICOM viewer module for viewing and processing “native” DICOM Imaging from any source known.

### Physicians and Practice Groups

In various embodiments of the present invention disclosed herein, the term “physicians”, “care providers” or “doctor” refers to a physician administering patient care, as well as to those members of his/her staff responsible for maintaining the physician's patient records. Though the term is used interchangeably, it should be understood that in the exemplary figures and texts, each function is being performed by one or more persons that perform such activities in a particular doctor's office on behalf of a licensed physician.

The term “specialist” is applied to a physician administering secondary care to a patient after a referral from a referring physician, and is also applied to other members of his/her staff in the same manner as is done for the physician. It may be possible for any given physician to in one situation be a specialist (receiving a patient via referral), and in another be a primary care physician (referring a patient to another physician for specialized care).

Further a “provider group” or “practice group” may be any entity linking a group of doctors through shared facilities, services, or referral agreements. This can include but should not be limited to Integrated multi-facility hospitals, medical groups, and multi-doctor practices.

### System, Method and Computer Program

As will be appreciated by one skilled in the art, the present invention may be embodied as an apparatus or method, including a computer system or computer program product. Accordingly, unless specified to the contrary, the present invention may take the form of an entirely hardware embodiment, and entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code stored in the medium.

Any combination of one or more computer-usable or computer-readable medium(s) may be utilized, unless specified to the contrary herein. The computer-usable or computer-readable medium may be, for example, but not limited to, electronic, magnetic, optical, electromagnetic, infrared, or semiconductor storage mediums. More specific examples (a non-exhaustive list) include: a portable computer diskette, a hard disc, a random access memory (RAM), a read-only memory (ROM), an erasable programmable read-only memory (EPROM or Flash Memory), and a portable compact disc read-only memory (CDROM), an optical storage device.

Further, the present invention is described above with reference to flowchart illustrations and/or block diagrams of methods, apparatus and computer program products (systems) according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams illustrate the architecture, functionality, and operation of possible implementations of systems, methods and computer program products according to various embodiments of the present invention. In this regard, each block in the flowchart or block diagrams may represent a module, segment, or portion of code, which comprise one or more executable instructions for implementing the specified logical function(s). It should also be noted that, in some alternative implementations, the functions noted in the block may occur out of the order noted in the figures. For example, two blocks shown in succession may in fact, be executed substantially concurrently, or the blocks may sometimes be executed in the reverse order, depending upon the functionality involved. It will also be noted that each block of the block diagrams and/or flowchart illustration, and combinations of blocks in a block diagrams and/or flowchart illustration, can be implemented by special purpose hardware-based systems that perform the specified functions or acts, or combinations of special purpose hardware and computer instructions.

Although the above description contains many specificities, these should not be construed as limiting the scope of the invention but as merely providing illustrations of some of the presently preferred embodiments of this invention. As such, it is to be understood that the present invention is not limited to the embodiments described above, but encompasses any and all embodiments within the scope of the claims.

I claim:

1. An online system for transmitting patient medical records, comprising:
a cloud system,
an HIE application configured as a software application,
a Dongle device for storage and transport of said HIE application, wherein said HIE application accessible to a user terminal to allow a user to use a medical information processing service, and inducing access to the cloud system taking charge of medical information processing,
a personal health records module,
wherein said personal health records module for receiving and managing patient records and transmitting selected patient records to said HIE application, and
wherein said Dongle and HIE application are used by a referred physician for receiving said selected patient records from said personal health records module and transmitting selected data from the referred physician's computer system to said HIE application and said personal health records module,
said HIE application further including a user interface enabling the user to select patient records on said personal health records module for accessing by the referred physician,
said HIE application further including a security module such that the referred physician is unable to access said selected patient records without a unique identifier.

2. The online system as recited in claim 1, wherein the user is connected to the HIE application to transmit to the cloud system in real-time.

3. The online system as recited in claim 2, wherein the HIE application comprises an interface function of accessing from said user terminal to said cloud system and a function of outputting, managing, and software processing an event generated by the personal health records module and the physician's module and expressed as an icon usable by the user.

4. The online system as recited in claim 3, further including a platform connection module that provides a function of connecting between platforms for managing the cloud system for medical information processing and information resourced and allows a user terminal comprising a function of virtualizing resources necessary for service processing to access the cloud system.

5. The system as recited in claim 4, wherein the HIE application provides a function of checking a physician's identifier, securing an authority to use and access said selected patient records saved on the Dongle.

6. The system as recited in claim 5, further enabling the distant care provider to form a response and save said response on said initiator.

7. The system as recited in claim 6, further including reconciliation means to compare said response with the patient records on the personal health records module.

8. The system as recited in claim 7, further including means to merge the response with the personal health records module.

9. The system as recited in claim 8, wherein said user terminal stores an up-to-date medical records file for retrieval by the user or a care provider when said user terminal is connected with said cloud system.

10. An online transfer of patient medical records apparatus comprising:
an initiator for creating and processing of data compilation and dissemination of patient medical records between an originating source and a distant care provider,
an application software stored on said initiator,
a web access to cloud device for connecting and communicating with a personal health records module that is a central repository for all patient medical records,
a user interface enabling the originating source to select medical records from the personal health records module and store on the initiator to enable access by the distant care provider based on a filtered combination of the available patient medical records,
wherein said initiator and said software application are used by the distant care provider for receiving said selected medical records and transmitting a response from the distant care provider's computer system to said software application and said personal health records module,
wherein said response is in a structured format,
reconciliation means to compare the response with the medical records on the personal health records module, and
wherein said distant care provider is unable to access said selected medical records without a unique identifier.

11. The apparatus as recited in claim 10, wherein the user interface is accessible via a web browser for filtering and selecting the medical records to be accessed by the distant care provider.

12. The apparatus as recited in claim 11, wherein the initiator is a data storage device.

13. The apparatus as recited in claim 12, wherein said web enabling device is a user computer.

14. The apparatus as recited in claim 13, wherein the originating source is a patient.

15. The apparatus as recited in claim 14, wherein the originating source is a primary care provider.

16. A method for transferring patient medical records comprising the steps of:
a user accessing a personal health records module through a web enabling device, an initiator, and a software application stored on the initiator, said web enabling device for web access to a cloud device for connecting and communicating with said personal health records module;
selecting patient data from said personal health records module;
securely storing said selected patient data on said initiator; and
delivering said initiator to a referred physician;
the referred physician performing in the following steps:
connecting the initiator to the referred physician's computer;
accessing the application software stored on the initiator;
responding to a security question(s) from said software application;
reviewing the securely stored selected patient data;
recording the referred physician's recommendations on the initiator, said recommendations including said selected patient data;
delivering said initiator to said user;
the user performing the following steps:
creating an accepted file by reconciling said recommendations with the personal health records module; and
merging said accepted file with said personal health records module.

17. The method as recited in claim 16, wherein said selected patient data and said recommendations are in structured form.

18. The method as recited in claim 17, further comprising the step of the referred physician transmitting said recommendations via the Internet to a primary care provider.

19. The method as recited in claim 18, wherein the user is a patient.

20. The method as recited in claim 16, wherein the accessing said personal health records module step is in real-time.
